(19) United States
(12) Patent Application Publication
(10) Pub. No.: US 2014/0029454 A1
(43) Pub. Date: Jan. 30, 2014

(54) APPARATUS AND METHOD FOR TRANSMITTING/RECEIVING CHANNEL QUALITY INDICATOR IN COMMUNICATION SYSTEM

(71) Applicant: SAMSUNG ELECTRONICS CO. LTD., Suwon-si (KR)

(72) Inventors: Hyun-Seok YU, Seoul (KR); Seong-Wook SONG, Gwacheon-si (KR); Kyung-Ha LEE, Yongin-si (KR)

(73) Assignee: SAMSUNG ELECTRONICS CO. LTD., Suwon-si (KR)

(21) Appl. No.: 13/799,643

(22) Filed: Mar. 13, 2013

(30) Foreign Application Priority Data
Jul. 25, 2012 (KR) 10-2012-0080958

(51) Int. Cl. H04W 24/10

(52) U.S. Cl. CPC H04W 24/10
USPC 370/252; 370/329

(57) ABSTRACT

A method for transmitting a Channel Quality Indicator (CQI) by a CQI transmission apparatus in a communication system is provided. The method includes generating a CQI based on a CQI metric generated using a CQI_offset compensation value, and transmitting the CQI to a CQI reception apparatus, wherein the CQI_offset compensation value is generated using a CQI_offset and wherein a CQI_offset control value, and the CQI_offset is generated using Acknowledgement (Ack)/Non-Acknowledgement (Nack) information for a transmitted transport block.

### PRIORITY

This application claims the benefit under 35 U.S.C. §119(a) of a Korean Patent Application filed on Jul. 25, 2012 in the Korean Intellectual Property Office and assigned Serial No. 10-2012-0080958, the entire disclosure of which is hereby incorporated by reference.

### BACKGROUND OF THE INVENTION

1. Field of the Invention

The present invention relates to an apparatus and method for transmitting/receiving a Channel Quality Indicator (CQI) in a communication system. More particularly, the present invention relates to an apparatus and method for transmitting/receiving a CQI thereby maximizing throughput in a communication system.

2. Description of the Related Art

Generally, CQI transmission/reception is important to contribute to a performance of a communication system. Accordingly, accurately generating a CQI is also important to contribute to the performance of the communication system.

Various CQI generation schemes have been proposed, and the various CQI generation schemes will be described below.

The first CQI generation scheme is a scheme in which a reception end User Equipment (UE) estimates a Signal and Interference power to Noise power Ratio (SINR), quantizes the estimated SINR, and generates a final CQI.

The second CQI generation scheme is a scheme in which a reception end UE generates a final CQI using an SINR and an offset in order to correct an error which may occur if the reception end UE generates the final CQI using only the SINR. The second CQI generation scheme will be referred to as an ‘Outer Loop (OL) control scheme’. In the second CQI generation scheme, an offset based on a Block Error Rate (BLER) may apply in order to detect an offset reflecting practical throughput, in this case, the reception end UE determines whether a short term BLER which is estimated during a relatively short time is an appropriate level, and determines an offset based on the determination result.

In the first CQI generation scheme, performances are not the same although SINRs of the reception end UE are the same. Further, in the first CQI generation scheme, there is a high probability of using a transport block and a modulation scheme inappropriate for a practical channel status due to a limitation of accuracy and suitability for an SINR estimation if a Node B performs a scheduling based on an SINR.

The second CQI generation scheme has an advantage relative to the first CQI generation scheme. However, the second CQI generation scheme still has problems associated therewith. Such problems with the second CGI generation scheme are described as below.

Firstly, with regard to the second CGI generation scheme, it is necessary to estimate the most accurate short term BLER for generating an optimal CQI in fast fading environment. However, such an estimation necessarily needs an estimation window with a relatively long time interval. As such, there is a high probability of changing channel status at a timing point at which an offset estimation value is acquired. In other words, length and accuracy of a short term BLER estimation duration, and a Doppler speed of a fading may mutually contribute to limit a performance. Consequently, it is difficult to estimate an accurate offset.

Secondly, with regard to the second CGI generation scheme, it is necessary to set a target BLER as an optimal value based on channel status. However the detailed scheme has not been proposed up to now. Typically, in an Additive White Gaussian Noise (AWGN) environment, it is desirable to maximize throughput if the target BLER is ‘0.1 (10%)’ (e.g., target BLER=0.1), and in a fading channel environment, it is desirable to maximize throughput if the target BLER is equal to or greater than ‘0.1’. However, in the second CQI generation scheme, a scheme for setting a target BLER has not been proposed up to now.

Therefore, a need exists for an apparatus and method for transmitting/receiving a CQI in a communication system.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for synchronizing use information between mobile communication terminals comprising short-range wireless communication units.

An aspect of the present invention is to provide an apparatus and method for transmitting/receiving a CQI in a communication system.

Another aspect of the present invention is to provide an apparatus and method for transmitting/receiving a CQI thereby maximizing throughput in a communication system.

Another aspect of the present invention is to provide an apparatus and method for transmitting/receiving a CQI by adaptively reflecting channel status in a communication system.

In accordance with an aspect of the present invention, an apparatus in a communication system for a Channel Quality Indicator (CQI) transmission is provided. The CQI transmission apparatus includes a generator for generating a CQI based on a CQI metric generated using a CQI_offset compensation value; and a transmitter for transmitting the CQI to a CQI reception apparatus, wherein the CQI offset compensation value is generated using a CQI_offset and a CQI_offset control value, and wherein the CQI_offset is generated using Acknowledgement (Ack)/Non-Acknowledgement (Nack) information for a transmitted transport block.

In accordance with another aspect of the present invention, an apparatus in a communication system for a Channel Quality Indicator (CQI) reception is provided. The CQI reception apparatus includes a receiver for receiving a CQI generated based on a CQI metric generated using a CQI_offset compensation value from a CQI transmission apparatus, wherein the CQI_offset compensation value is generated using a CQI_offset and a CQI_offset control value, and wherein the CQI offset is generated using Acknowledgement (Ack)/Non-Acknowledgement (Nack) information for a transmitted transport block.

In accordance with further another aspect of the present invention, a method for transmitting a Channel Quality Indicator (CQI) by a CQI transmission apparatus in a communication system is provided. The method includes generating a CQI based on a CQI metric generated using a CQI_offset compensation value; and transmitting the CQI to a CQI reception apparatus, wherein the CQI_offset compensation value is generated using a CQI_offset and a CQI_offset control value, and wherein the CQI_offset is generated using Acknowledgement (Ack)/Non-Acknowledgement (Nack) information for a transmitted transport block.

In accordance with still another aspect of the present invention, a method for receiving a Channel Quality Indicator (CQI) by a CQI reception apparatus in a communication system is provided. The method includes receiving a CQI generated based on a CQI metric generated using a CQI_offset compensation value from a CQI transmission apparatus, wherein the CQI_offset compensation value is generated using a CQI_offset and a CQI_offset control value, and wherein the CQI offset is generated using Acknowledgement (Ack)/Non-Acknowledgement (Nack) information for a transmitted transport block.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram schematically illustrating an internal structure of a Channel Quality Indicator (CQI) transmission apparatus in a communication system according to an exemplary embodiment of the present invention;

FIG. 2 is a block diagram schematically illustrating an internal structure of a CQI generator, for example, the CQI generator illustrated in FIG. 1, according to an exemplary embodiment of the present invention;

FIG. 3 schematically illustrates an operation of acquiring throughput using a CQI_offset adjustment in a CQI transmission apparatus according to an exemplary embodiment of the present invention;

FIG. 4 schematically illustrates a matrix representing an estimated narrow band and a channel estimation result of a sampling position according to an exemplary embodiment of the present invention;

FIG. 5 is a block diagram schematically illustrating an internal structure of a target Block Error Rate (BLER) generation unit if a diversity order in a frequency domain and a diversity order in a time domain are individually considered according to an exemplary embodiment of the present invention;

FIG. 6 is a block diagram schematically illustrating an internal structure of a target BLER generation unit if a combined diversity order generated by combining a diversity order in a frequency domain and a diversity order in a time domain is considered according to an exemplary embodiment of the present invention;

FIG. 7 is a block diagram schematically illustrating an internal structure of a CQI metric generation unit, for example, the CQI metric generation unit illustrated in FIG. 2, according to an exemplary embodiment of the present invention; and

FIG. 8 is a flowchart schematically illustrating an operation of a CQI transmission apparatus in a communication system according to an exemplary embodiment of the present invention.

The same reference numerals are used to represent the same elements throughout the drawings.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An exemplary embodiment of the present invention proposes an apparatus and method for transmitting/receiving a Channel Quality Indicator (CQI) in a communication system.

Another exemplary embodiment of the present invention proposes an apparatus and method for transmitting/receiving a CQI in a communication system thereby maximizing throughput.

Further another exemplary embodiment of the present invention proposes an apparatus and method for transmitting/receiving a CQI in a communication system by adaptively reflecting channel status.

Exemplary embodiments of the present invention will be described below with reference to a communication system such as, for example, one of a High Speed Downlink Packet Access (HSDPA) system, an Institute of Electrical and Electronics Engineers (IEEE) 802.16 system, a Long-Term Evolution (LTE) system, a Long Term Evolution Advanced (LTE-A) system, and the like. However, it will be understood by those of ordinary skill in the art that an apparatus and method for transmitting/receiving a CQI proposed in exemplary embodiments of the present invention may be applied to any other communication systems. Further, according to exemplary embodiments of the present invention a CQI transmission apparatus may be included in a User Equipment (UE), and a CQI reception apparatus may be included in a Node B.

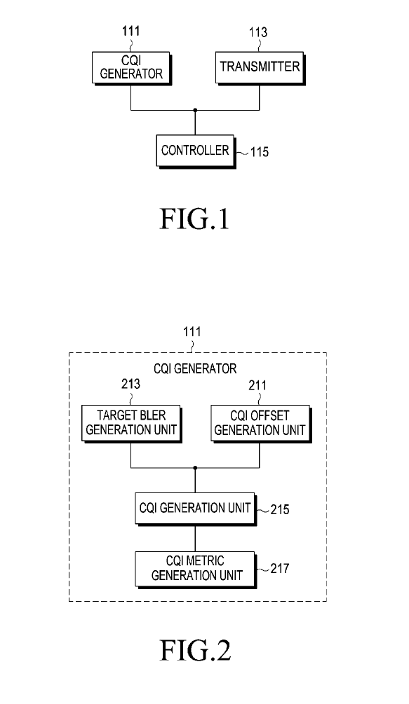

FIG. 1 is a block diagram schematically illustrating an internal structure of a CQI transmission apparatus in a communication system according to an exemplary embodiment of the present invention.

Referring to FIG. 1, a CQI transmission apparatus includes a CQI generator 111, a transmitter 113, and a controller 115.

According to exemplary embodiments of the present invention, the controller 115 controls the overall operation of the CQI transmission apparatus. The CQI generator 111 generates a CQI under a control of the controller 115. As an example, an internal structure of a CQI generator such as CQI generator 111 will be described with reference to FIG. 2, so the detailed description will be omitted herein. The transmitter 113 transmits the CQI generated by the CQI generator 111 to a CQI reception apparatus under a control of the controller 115.

Although the CQI generator 111, the transmitter 113, and the controller 115 are shown in FIG. 1 as separate units, it is to be understood that this is for merely convenience of description. In other words, the CQI generator 111, the transmitter 113, and the controller 115, or any combination thereof, may be incorporated into a single unit.

FIG. 2 is a block diagram schematically illustrating an internal structure of a CQI generator, for example, the CQI generator illustrated in FIG. 1, according to an exemplary embodiment of the present invention.

Referring to FIG. 2, a CQI generator 111 includes a CQI_offset generation unit 211, a target Block Error Rate (BLER) generation unit 213, a CQI generation unit 215, and a CQI metric generation unit 217. Although the CQI_offset generation unit 211, the target BLER generation unit 213, the CQI generation unit 215, and the CQI metric generation unit 217 are shown in FIG. 2 as separate units, it is to be understood that this is for merely convenience of description. In other words, the CQI_offset generation unit 211, the target BLER generation unit 213, the CQI generation unit 215, and the CQI metric generation unit 217, or any combination thereof may be incorporated into a single unit.

According to an exemplary embodiment of the present invention, the CQI generation unit 215 generates a CQI using Acknowledgement (Ack)/Non-Acknowledgement (Nack) information and a target BLER. The CQI may be expressed as provided below in Equation (1).

CQI_index=F(CQI_metric) (1)

where CQI_index denotes a CQI, CQI_metric denotes a CQI metric, and F(CQI_metric) denotes a function for generating the CQI with a variable as the CQI_metric. It will be understood by those of ordinary skill in the art that the F(CQI_metric) may be implemented in various forms. For example, the CQI generation unit 215 generates a CQI index using Equation (1), an operation of the CQI generation unit 215 will be described below. Therefore, the detailed description of such will be omitted herein.

The CQI_metric may be expressed as provided below in Equation (2).

CQI_metric=CQI_metric_{raw}+CQI_offset_comp (2)

where CQI_metric_{raw} denotes a raw CQI metric, and CQI_offset_comp denotes a CQI offset compensation value. For example, the CQI metric generation unit 217 generates a CQI metric using Equation (2), an operation of the CQI metric generation unit 217 will be described below, so the detailed description will be omitted herein.

The CQI_metric_{raw} may be expressed as provided below in Equation (3).

CQI_metric_{row}=M(SINR,Doppler) (3)

where SINR denotes a Signal and Interference power to Noise power Ratio (SINR), Doppler denotes a Doppler speed, and M(SINR, Doppler) denotes a function for generating the CQI_metric_{raw} with variables corresponding to the SINR and Doppler. It will be understood by those of ordinary skill in the art that the M(SINR, Doppler) may be implemented in various forms.

The CQI_offset is generated by the CQI_offset generation unit 211, and may be expressed as provided below in Equation (4).

CQI_offset=CQI_OFFSET_{—}ACC/micro_step (4)

where micro_step denote a step value for adjusting the CQI_offset. The CQI_OFFSET_ACC may be expressed as provided below in Equation (5).

CQI_OFFSET_{—}ACC(t+1)=CQI_OFFSET_{—}ACC(t)+I_{—}ack*TargetBLER+I_nack(1−TargetBLER) (5)

where t denotes a variable representing an arbitrary timing point, and TargetBLER denotes a target BLER. The I_ack and I_nack may be expressed as provided below in Equation (6).

$$( \begin{matrix}I\_ack = \{ \begin{matrix}0 \text{:} & Nack in Transport Block \\ 1 \text{:} & Ack in Transport Block\end{matrix} \\ I\_nack = \{ \begin{matrix}1 \text{:} & Nack in Transport Block \\ 0 \text{:} & Ack in Transport Block\end{matrix}\end{matrix} ) \qquad ( 6 )$$

where I_ack is set to ‘0’ if Nack information is generated for a related transport block, and is set to ‘1’ if Ack information is generated for a related transport block. In Equation (6), I_nack is set to ‘1’ if Nack information is generated for a related transport block, and is set to ‘0’ if Ack information is generated for a related transport block.

As described in Equations (4) to (6), the CQI_offset is determined using a Markov process which immediately reflects the Ack/Nack information, so the most serious problem in the first and second CQI generation schemes may be solved. For example, the most serious problem in the first and second CQI generation schemes represents that a CQI is generated without adaptively reflecting channel status.

As an example, if the CQI_offset is determined as described in Equations (4) to (6), a loop operation is performed so that a ratio of Ack information to Nack information and a target BLER become equal thereby the CQI_offset generation unit 211 immediately enables a change in the CQI_offset without any duration estimation such as a short term BLER. In order to adjust a speed for reflecting the ratio of Ack information to Nack information for the CQI_offset, the CQI_offset generation unit 211 generates the CQI_offset by dividing the CQI_OFFSET_ACC into the micro_step, and the micro_step as expressed in Equation (4) may be determined according to channel status and a Doppler speed. For example, the micro_step may be set to a relatively small value if channel status is relatively high-speed channel status, and may be set to a relatively large value if the channel status is relatively low-speed channel status.

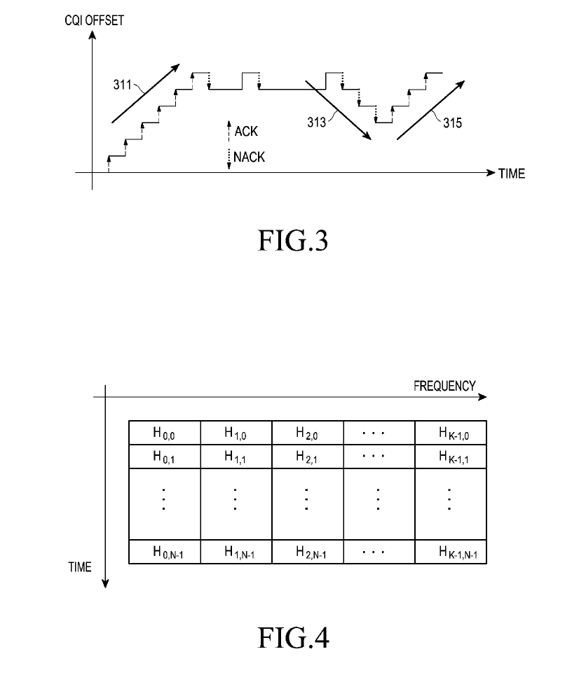

Meanwhile, if Ack information successively occurs when transport blocks are practically transmitted/received, the CQI_offset has successively positive values, so the CQI_index is increased. In contrast, if Nack information successively occurs when the transport blocks are practically transmitted/received, the CQI_offset has successively negative values, so the CQI_index is decreased. In this case, a Node B may adjust a transport block size and a code rate which are applied to a transport block to be transmitted, so a throughput may be maximized by adaptively reflecting Ack/Nack information in a fading environment. This operation will be described with reference to FIG. 3.

FIG. 3 schematically illustrates an operation of acquiring throughput using a CQI_offset adjustment in a CQI transmission apparatus according to an exemplary embodiment of the present invention.

Referring to FIG. 3, a graph illustrated that represents a relationship among a time, a CQI_offset, and throughput. If Nack information occurs in a BLER less than a target BLER, throughput is acquired by increasing a CQI_offset in step 311. If the Nack information occurs in a BLER equal to or greater than the target BLER, the throughput is acquired by decreasing the CQI_offset in step 313. And, if the Nack information occurs in a BLER less than the target BLER, the throughput is acquired by increasing the CQI_offset in step 315. For example, if Ack information occurs, the CQI_offset has successively a positive value, so a CQI_index is increased. In contrast, if Nack information successively occurs, the CQI_offset has successively a negative value, so the CQI_index is decreased. In this case, a Node B may adjust a transport block size and a code rate which are applied to a transport block to be transmitted, so a throughput may be maximized by adaptively reflecting Ack/Nack information in afading environment.

Meanwhile, in an exemplary embodiment of the present invention, if a retransmission such as the second transmission, and the third transmission occurs after the first transmission, it is considered that a CQI_OFFSET_ACC and a CQI_offset_comp are rapidly decreased by regarding the retransmission as sharp performance degradation in a small electric field. As a practical matter, if a Hybrid Automatic Retransmit request (HARQ) scheme is used, a probability of Ack information for a retransmitted transport block is sharply increased. Accordingly, successive retransmission failure (i.e., occurrence of Nack information) represents that current channel status is worst. Therefore, there is a need for compensating the CQI_offset according to channel status expressed as provided below in Equation (7).

CQI_offset_comp=CQI_offset+OFFSET_CONTROL_{—}VAL (7)

where OFFSET_CONTROL_VAL denotes a CQI offset control value determined according to a retransmission number, and may be set to different values according to the retransmission number. As described above, if the retransmission number becomes increased, it is regarded that sharp performance degradation occurs in a small electric field, so a CQI_OFFSET_ACC value and a CQI_offset_comp value shall be rapidly decreased. Therefore, if the retransmission number becomes increased, an OFFSET_CONTROL_VAL becomes increased, and the OFFSET_CONTROL_VAL is ‘0’ if the retransmission number is ‘0’.

As a result, the CQI generation unit 215 generates a CQI_offset_comp using the CQI_offset generated by the CQI_offset generation unit 211 and an OFFSET_CONTROL_VAL determined according to the retransmission number.

As described above, the target BLER generation unit 213 shall adaptively set a target BLER by considering related channel status in order to adaptively adjust a CQI_offset based on channel status.

Generally, throughput according to a BLER is modeled as provided below in Equation (8) if a HARQ scheme is used.

$$Throughput = TBS \cdot ( \frac{1 - {p}_{0} {p}_{1} {p}_{0} … {P}_{N}}{1 + {p}_{0} + {p}_{0} {p}_{1} + … + {p}_{0} {p}_{1} … {p}_{N - 1}} ) \qquad ( 8 )$$

where TBS denotes a transport block size, p₀ denotes a BLER of a transport block initially transmitted, p₁ denotes a BLER of a transport block secondly transmitted (e.g., firstly retransmitted), and in this manner, p_{N} denotes a BLER of a transport block in the N+1th transmission (e.g., the Nth retransmission).

As described in Equation (8), a BLER and a transport block size per transmission are important to contribute to maximize throughput. If throughput is determined by considering only initial transmission for an arbitrary transport block without retransmission for the arbitrary transport block, it is advantageous that a low BLER is maintained using an appropriate transport block size.

In contrast, it will be assumed that there is a need to retransmit the arbitrary transport block, and that the BLER is sharply decreased if the arbitrary transport block is retransmitted. In this case, if a transport block with a relatively large transport block size is transmitted, a retransmitted transport block is successively transmitted with a relatively high probability although Nack information occurs on an initially transmitted transport block, so a BLER for an initial transmission is set to a relatively high value and throughput becomes increased.

A typical example is that a diversity order of a channel is relatively high, if the diversity order is relatively high, channel status for retransmission has a low correlation to a previous transmission. Accordingly, a relatively large diversity effect is acquired. Consequently, an Ack information occurrence probability for an arbitrary transport block becomes higher. Finally, if a diversity of a channel becomes higher, an effect of retransmission becomes increased, such that transmitting much data using a relatively large transport block size results in increasing total throughput although a relatively high BLER occurs in initial transmission.

In contrast, in retransmission, a Nack information occurrence probability for an arbitrary transport block does not decrease seriously although a diversity of a channel becomes lower. Accordingly, it is desirable for maximizing a success probability for initial transmission, and this means that it is desirable for setting a relatively low target BLER. Therefore, an exemplary embodiment of the present invention proposes a method for measuring a diversity order considering frequency selectivity of a channel and a Doppler, and setting an optimal target BLER based on the measured diversity order.

A diversity order estimation scheme may be implemented in various forms. According to an exemplary embodiment of the present invention, it will be assumed that a diversity order estimation scheme using a Normalized Mean Square Covariance (NMSV) of a channel is used, and this will be described with reference to Equations provided below.

FIG. 4 schematically illustrates a matrix representing an estimated narrow band and a channel estimation result of a sampling position according to an exemplary embodiment of the present invention.

It will be assumed that a channel estimated in a time domain is h(τ,t), and a channel estimated in a frequency domain is H(f,t). In h(τ,t), τ denotes a multipath length, and t denotes an arbitrary timing point. In H(f,t), f denotes a specific frequency.

A discrete sampling result for the estimated channel is modeled as provided below in Equation (9).

H_{k,n}:Frequency response of H(f,t) at f=kΔf,t=nΔt (9)

where H_{k,n} denotes a frequency response of H(f,t) estimated in the frequency domain if a frequency f is kΔf, and a timing point t is nΔt, Δf represents a bandwidth of a narrow band, and Δt represents a sampling period.

The estimated narrow band and a channel estimation result of a sampling position may be stored in the matrix form as illustrated in FIG. 4, the channel estimation result stored in the matrix form may be used for estimating an NMSV, and this will be detailed described below.

A Normalized Frequency Mean Square Covariance (NFMSV) may be expressed as provided below in Equation (10).

$${V}_{f} ( n ) = \frac{{\sum }_{k = 0}^{K - 1} {\sum }_{l = 0}^{K - 1} {\vert E [ {H}_{k , n} {H}_{l , n}^{*} ] \vert}^{2}}{[ {\sum }_{k = 0}^{K - 1} E [ {\vert {H}_{k , n} \vert}^{2} ] ]} \qquad ( 10 )$$

where V_{f}(n) denotes an NFMSV.

A Normalized Time Mean Square Covariance (NTMSV) may be expressed as provided below in Equation (11).

$${V}_{t} ( k ) = \frac{{\sum }_{n = 0}^{N - 1} {\sum }_{m = 0}^{N - 1} {\vert E [ {H}_{k , n} {H}_{k , m}^{*} ] \vert}^{2}}{[ {\sum }_{n = 0}^{N - 1} E [ {\vert {H}_{k , n} \vert}^{2} ] ]} \qquad ( 11 )$$

where Vₜ(k) denotes an NTMSV.

An NMSV combined a covariance in the time domain with a covariance in the frequency domain may be expressed as provided below in Equation (12).

$$V = \frac{{\sum }_{k = 0}^{K - 1} {\sum }_{l = 0}^{K - 1} {\sum }_{n = 0}^{N - 1} {\sum }_{m = 0}^{N - 1} {\vert E [ {H}_{k , n} {H}_{l , n}^{*} ] \vert}^{2}}{[ {\sum }_{k = 0}^{K - 1} {\sum }_{n = 0}^{N - 1} E [ {\vert {H}_{k , n} \vert}^{2} ] ]} \qquad ( 12 )$$

where V denotes an NMSV.

A diversity order (i.e., an effective degree of freedom) may be expressed as provided below in Equation (13), so effective diversity orders in each of the time, frequency, and combination domain may be detected.

D_{f}=1/V_{f},Dₜ=1/Vₜ,D=1/V (13)

where D_{f} denotes an effective diversity order in the frequency domain, Dₜ denotes an effective diversity order in the time domain, and D denotes an effective diversity order in the combination domain.

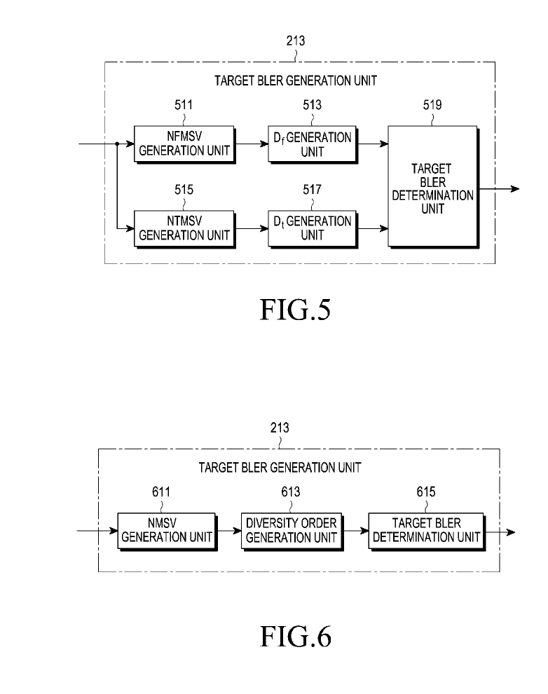

As described above, setting a target BLER as an optimal value is very important to contribute to maximizing whole throughput of a communication system. According to an exemplary embodiment of the present invention, the target BLER generation unit 213 may be implemented by considering each of a diversity order in the frequency domain and a diversity order in the time domain, or may be implemented by considering a combined diversity order generated by combining the diversity order in the frequency domain with the diversity order in the time domain. This will be described with reference to FIGS. 5 to 6.

Firstly, the target BLER generation unit 213 may be implemented by considering each of the diversity order in the frequency domain and the diversity order in the time domain, this will be detailed described with reference to FIG. 5.

FIG. 5 is a block diagram schematically illustrating an internal structure of a target BLER generation unit if a diversity order in a frequency domain and a diversity order in a time domain are individually considered according to an exemplary embodiment of the present invention.

Referring to FIG. 5, a target BLER generation unit 213 includes an NFMSV generation unit 511, a D_{f} generation unit 513, an NTMSV generation unit 515, a Dₜ generation unit 517, and a target BLER determination unit 519.

According to exemplary embodiments of the present invention, if channel estimation result is transferred to the target BLER generation unit 213, the channel estimation result is input to the NFMSV generation unit 511 and the NTMSV generation unit 515. The NTMSV generation unit 515 generates an NFMSV Vf using the channel estimation result, and outputs the NFMSV Vf to the D_{f} generation unit 513. The D_{f} generation unit 513 generates a D_{f} using the NFMSV Vf and outputs the D_{f} to the target BLER determination unit 519.

The NTMSV generation unit 515 generates an NTMSV Vₜ using the channel estimation result, and outputs the NTMSV Vₜ to the Dₜ generation unit 517. The Dₜ generation unit 517 generates a Dₜ using the NTMSV Vₜ and outputs the Dₜ to the target BLER determination unit 519.

The target BLER determination unit 519 stores a target BLER table, detects a related target BLER from the target BLER table using the D_{f} and Dₜ, and outputs the detected target BLER. The target BLER table stored in the target BLER determination unit 519 may be expressed as provided below in Table 1.

TABLE 1

| | Dₜ | | | |
|---|---|---|---|---|
| D_{f} | TIME_TH_0 | TIME_TH_1 | • • • | TIME_TH_Y |
| FREQ_TH_0 | 0.1 | 0.15 | • • • | 0.70 |
| FREQ_TH_1 | 0.2 | 0.25 | • • • | 0.70 |
| • | • | • | • • • | • |
| • | • | • | | • |
| • | • | • | | • |
| FREQ_TH_X | 0.25 | 0.35 | • • • | 0.75 |

As described in Table 1, target BLERs are mapped in the target BLER table according to the D_{f} and Dₜ, the target BLER determination unit 519 detects a target BLER according to the D_{f} and Dₜ, and outputs the detected target BLER. For example, in Table 1, if the D_{f} is FREQ_TH_0, and the Dₜ is TIME_TH_0, the target BLER determination unit 519 determines the target BLER as “0.1”.

Although the NFMSV generation unit 511, the D_{f} generation unit 513, the NTMSV generation unit 515, the Dₜ generation unit 517, and the target BLER determination unit 519 are shown in FIG. 5 as separate units, it is to be understood that this is for merely convenience of description. In other words, the NFMSV generation unit 511, the D_{f} generation unit 513, the NTMSV generation unit 515, the Dₜ generation unit 517, and the target BLER determination unit 519, or any combination thereof, may be incorporated into a single unit.

Secondly, the target BLER generation unit 213 may be implemented by considering a combined diversity order generated by combining the diversity order in the frequency domain with the diversity order in the time domain, this will be detailed described with reference to FIG. 6.

FIG. 6 is a block diagram schematically illustrating an internal structure of a target BLER generation unit if a combined diversity order generated by combining a diversity order in a frequency domain and a diversity order in a time domain is considered according to an exemplary embodiment of the present invention.

Referring to FIG. 6, a target BLER generation unit 213 includes an NMSV generation unit 611, a diversity order generation unit 613, and a target BLER determination unit 615.

According to exemplary embodiments of the present invention, if channel estimation result is transferred to the target BLER generation unit 213, the channel estimation result is input to the NMSV generation unit 611. The NMSV generation unit 611 generates an NMSV V using the channel estimation result, and outputs the NMSV V to the diversity order generation unit 613. The diversity order generation unit 613 generates a diversity order using the NMSV V and outputs the diversity order to the target BLER determination unit 615.

The target BLER determination unit 615 stores a target BLER table, detects a related target BLER from the target BLER table using the diversity order output from the diversity order generation unit 613, and outputs the detected target BLER. The target BLER table stored in the target BLER determination unit 615 may be expressed as provided below in Table 2.

TABLE 2

| D | Target BLER |
|---|---|
| DIV_TH_0 | 0.1 |
| DIV_TH_1 | 0.2 |
| • | • |
| • | • |
| • | • |
| DIV_TH_X | 0.65 |

As described in Table 2, target BLERs are mapped in the target BLER table according to a diversity order D, the target BLER determination unit 615 detects a target BLER according to the diversity order D, and outputs the detected target BLER. For example, in Table 2, if the diversity order D is DIV_TH_0, the target BLER determination unit 615 determines the target BLER as “0.1”.

Although the NMSV generation unit 611, the diversity order generation unit 613, and the target BLER determination unit 615 are shown in FIG. 6 as separate units, it is to be understood that this is for merely convenience of description. In other words, the NMSV generation unit 611, the diversity order generation unit 613, and the target BLER determination unit 615, or any combination thereof, may be incorporated into a single unit.

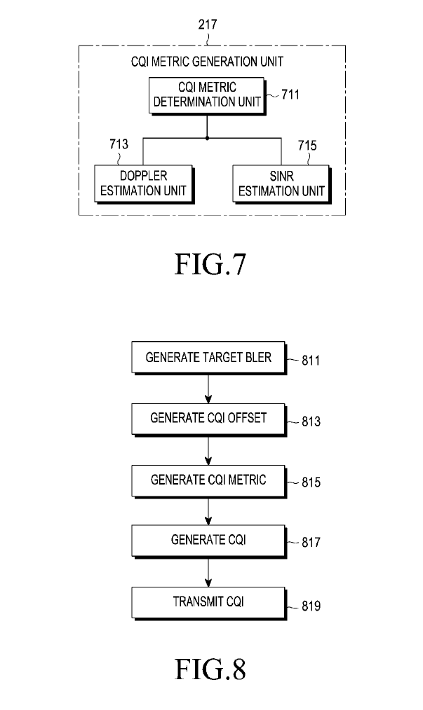

FIG. 7 is a block diagram schematically illustrating an internal structure of a CQI metric generation unit, for example, the CQI metric generation unit illustrated in FIG. 2, according to an exemplary embodiment of the present invention.

Referring to FIG. 7, a CQI metric generation unit 217 includes a CQI metric determination unit 711, a Doppler estimation unit 713, and an SINR estimation unit 715. The Doppler estimation unit 713 estimates Doppler and outputs the estimated Doppler to the CQI metric determination unit 711. It will be understood by those of ordinary skill in the art that a Doppler estimation scheme may be implemented in various forms. The SINR estimation unit 715 estimates an SINR and outputs the estimated SINR to the CQI metric determination unit 711. It will be understood by those of ordinary skill in the art that an SINR estimation scheme may be implemented in various forms. The CQI metric determination unit 711 generates a CQI metric using the estimated Doppler and SINR. The CQI metric determination unit 711 determines the CQI metric as described in Equation (2), so the detailed description will be omitted.

FIG. 8 is a flowchart schematically illustrating an operation of a CQI transmission apparatus in a communication system according to an exemplary embodiment of the present invention.

Referring to FIG. 8, the CQI transmission apparatus generates a target BLER in step 811. According to exemplary embodiments of the present invention, the operation generating the target BLER has been performed in the manner described before with reference to FIGS. 2 to 7. The CQI transmission apparatus generates a CQI offset in step 813. According to exemplary embodiments of the present invention, the operation generating the CQI offset has been performed in the manner described before with reference to FIGS. 2 to 7. The CQI transmission apparatus generates a CQI metric in step 815. According to exemplary embodiments of the present invention, the operation generating the CQI metric has been performed in the manner described before with reference to FIGS. 2 to 7.

The CQI transmission apparatus generates a final CQI using the target BLER, CQI offset and CQI metric in step 817. The CQI transmission apparatus transmits the final CQI to a CQI reception apparatus in step 819.

Although the CQI transmission apparatus sequentially generates the target BLER, the CQI offset, and the CQI metric in FIG. 8, it is to be understood that this is merely for convenience of description. In other words, the CQI transmission apparatus may generate the target BLER, the CQI offset, and the CQI metric at the same time, or may generate the target BLER, the CQI offset, and the CQI metric in a sequence different from a sequence as described in FIG. 8.

Meanwhile, although not shown in any Figures, the CQI reception apparatus may include a receiver for receiving the final CQI transmitted from the CQI transmission apparatus.

As is apparent from the foregoing description, exemplary embodiments of the present invention enable CQI transmission/reception thereby maximizing throughput in a communication system.

In addition, exemplary embodiments of the present invention enable CQI transmission/reception by adaptively reflecting channel status without any estimating duration. Accordingly, exemplary embodiments of the present invention enable maximizing throughput of a communication system in a fast fading environment.

Further, exemplary embodiments of the present invention enable CQI transmission/reception thereby rapidly reflecting Acknowledgement (Ack)/Non-Acknowledgement (Nack) information for a transport block transmitted in a communication system, so as to enable minimizing degradation of throughput due to a temporary small electric field and a deep fading.

In addition, exemplary embodiments of the present invention enable CQI transmission/reception by estimating an effective diversity order and setting a target BLER in a communication system, so as to enable adaptively maximizing throughput based on channel status.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting a Channel Quality Indicator (CQI) by a CQI transmission apparatus in a communication system, the method comprising:
generating a CQI based on a CQI metric generated using a CQI offset compensation value; and
transmitting the CQI to a CQI reception apparatus,
wherein the CQI offset compensation value is generated using a CQI offset and a CQI offset control value, and
wherein the CQI offset is generated using Acknowledgement (Ack)/Non-Acknowledgement (Nack) information for a transmitted transport block.

2. The method of claim 1, wherein the CQI offset is generated using a target Block Error Rate (BLER).

3. The method of claim 2, wherein the target BLER is determined using a Normalized Mean Square Covariance (NMSV) diversity order of a channel.

4. The method of claim 3, wherein the CQI offset control value is determined according to a retransmission number for the transmitted transport block.

5. The method of claim 4, wherein the CQI offset control value becomes increased if the retransmission number for the transmitted transport block becomes increased, and is set to ‘0’ if the transmitted transport block is not retransmitted.

6. A method for receiving a Channel Quality Indicator (CQI) by a CQI reception apparatus in a communication system, the method comprising:
receiving a CQI generated based on a CQI metric generated using a CQI offset compensation value from a CQI transmission apparatus,
wherein the CQI offset compensation value is generated using a CQI offset and a CQI offset control value, and
wherein the CQI offset is generated using Acknowledgement (Ack)/Non-Acknowledgement (Nack) information for a transmitted transport block.

7. The method of claim 6, wherein the CQI offset is generated using a target Block Error Rate (BLER).

8. The method of claim 7, wherein the target BLER is determined using a Normalized Mean Square Covariance (NMSV) diversity order of a channel.

9. The method of claim 8, wherein the CQI offset control value is determined according to a retransmission number for the transmitted transport block.

10. The method of claim 9, wherein the CQI offset control value becomes increased if the retransmission number for the transmitted transport block becomes increased, and is set to ‘0’ if the transmitted transport block is not retransmitted.

11. A Channel Quality Indicator (CQI) transmission apparatus in a communication system, the method comprising:
a generator for generating a CQI based on a CQI metric generated using a CQI offset compensation value; and
a transmitter for transmitting the CQI to a CQI reception apparatus,
wherein the CQI offset compensation value is generated using a CQI offset and a CQI offset control value, and
wherein the CQI offset is generated using Acknowledgement (Ack)/Non-Acknowledgement (Nack) information for a transmitted transport block.

12. The CQI transmission apparatus of claim 11, wherein the CQI offset is generated using a target Block Error Rate (BLER).

13. The CQI transmission apparatus of claim 12, wherein the target BLER is determined using a Normalized Mean Square Covariance (NMSV) diversity order of a channel.

14. The CQI transmission apparatus of claim 13, wherein the CQI offset control value is determined according to a retransmission number for the transmitted transport block.

15. The CQI transmission apparatus of claim 14, wherein the CQI offset control value becomes increased if the retransmission number for the transmitted transport block becomes increased, and is set to ‘0’ if the transmitted transport block is not retransmitted.

16. A Channel Quality Indicator (CQI) reception apparatus in a communication system, the apparatus comprising:
a receiver for receiving a CQI generated based on a CQI metric generated using a CQI offset compensation value from a CQI transmission apparatus,
wherein the CQI offset compensation value is generated using a CQI offset and a CQI offset control value, and
wherein the CQI offset is generated using Acknowledgement (Ack)/Non-Acknowledgement (Nack) information for a transmitted transport block.

17. The CQI reception apparatus of claim 16, wherein the CQI offset is generated using a target Block Error Rate (BLER).

18. The CQI reception apparatus of claim 17, wherein the target BLER is determined using a Normalized Mean Square Covariance (NMSV) diversity order of a channel.

19. The CQI reception apparatus of claim 18, wherein the CQI offset control value is determined according to a retransmission number for the transmitted transport block.

20. The CQI reception apparatus of claim 19, wherein the CQI offset control value becomes increased if the retransmission number for the transmitted transport block becomes increased, and is set to ‘0’ if the transmitted transport block is not retransmitted.
